(19) United States
(12) Patent Application Publication
(10) Pub. No.: US 2016/0282612 A1
(43) Pub. Date: Sep. 29, 2016

(54) OPTICAL ELEMENT, LIGHT-SHIELDING COATING MATERIAL SET, AND METHOD FOR MANUFACTURING OPTICAL ELEMENT

(71) Applicant: CANON KABUSHIKI KAISHA, Tokyo (JP)

(72) Inventors: Ryo Ogawa, Kawasaki-shi (JP); Keiichiro Tsubaki, Numazu-shi (JP); Tetsuo Hino, Yamato-shi (JP); Reiko Kubota, Yokohama-shi (JP)

(21) Appl. No.: 15/057,906

(22) Filed: Mar. 1, 2016

(30) Foreign Application Priority Data
Mar. 2, 2015 (JP) 2015-040720

(51) Int. Cl. G02B 27/00; G02B 5/22; C03C 17/32; C09D 163/00

(52) U.S. Cl. CPC G02B 27/0018; C09D 163/00; G02B 5/223; C03C 17/32

(57) ABSTRACT

Provided is an optical element including a substrate and a light-shielding film in a part of the substrate. The light-shielding film contains a resin and a colorant. The resin is a cured epoxy resin having a first aryl unit represented by Formula (1) below in a side chain or a terminal.

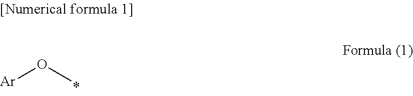

[In the formula, Ar represents a monocyclic unsubstituted aryl group, a polycyclic unsubstituted aryl group, a monocyclic substituted aryl group, or a polycyclic substituted aryl group.]

### BACKGROUND

1. Field of the Disclosure

The present disclosure relates to a light-shielding film for an optical element used for an optical apparatus such as a camera, binoculars, a microscope, or a semiconductor exposure apparatus, an optical element, and a method for manufacturing the same.

2. Description of the Related Art

The light-shielding film used for an optical element is an opaque thin film formed mainly on a surface of glass or plastic. The optical element may be a lens, a prism, or another optical glass. Hereinafter, the light-shielding film will be described using a lens as an example.

As illustrated in FIG. 6A, a light-shielding film used for an optical element is formed in an outer periphery of a lens 2 which is an optical element. When light strikes only the lens 2 like an incident light 3, the light passes through the lens 2 as a transmission light 4. Meanwhile, when an oblique incident light 5 is incident, the light strikes the light-shielding film 1. At this time, as illustrated in FIG. 6B, when the light-shielding film 1 is not formed, a part of the light which has struck the outer periphery of the lens 2 is reflected on an inner surface, and goes out of the lens 2 as a light 6 which has no relation to an image and has been reflected on the inner surface. This causes a flare or a ghost, and deteriorates an image quality. Provision with the light-shielding film can reduce inner surface reflection of the oblique incident light 5. Therefore, the light 6 which has a bad influence on an image and has been reflected on the inner surface is reduced, and a flare or a ghost can be prevented.

In addition, one of factors to cause a flare or a ghost is an influence by an inner scattered light in the light-shielding film 1. The scattered light in the light-shielding film 1 also has a bad influence on an image. Therefore, reduction in the inner scattering in the light-shielding film 1 also suppresses generation of a flare or a ghost.

U.S. Pat. No. 5,183,754 describes an optical element provided with a light-shielding film containing at least a resin, a dye, and non-black particles. US 2015/0022894 proposes a light-shielding film in which a light-shielding coating material having an equivalent ratio of an active hydrogen equivalent of an amine curing agent and an epoxy equivalent of an epoxy resin or the like defined has been cured in a light-shielding coating material containing the epoxy resin, a dye, and an amine curing agent. The light-shielding film described in US 2015/0022894 hardly causes film peeling at a high temperature and a high humidity and has a certain degree of solvent resistance due to increase in the cross-linking density of the epoxy resin.

In a light-shielding film, durability and solvent resistance at a high temperature and a high humidity are required in addition to reduction in inner surface reflection light. In a process of cleaning an optical element after a light-shielding film is formed or at the time of maintenance of a lens, the lens is cleaned with an organic solvent in order to remove a stain. When the solvent resistance is poor, by cleaning the lens provided with a light-shielding film with an isopropyl alcohol cleaning liquid, a colorant contained in the light-shielding film is eluted into the cleaning liquid, the blackness of the light-shielding film is lowered, and performance as a light-shielding film is deteriorated.

However, the light-shielding films described in U.S. Pat. No. 5,183,754 and US 2015/0022894 have insufficient solvent resistance. When the light-shielding films are cleaned with an organic solvent such as isopropyl alcohol, a colorant contained therein may be eluted into a cleaning liquid and the blackness of the light-shielding films may be lowered. When the blackness of the light-shielding film is lowered, sufficient performance as a light-shielding film cannot be exhibited for a long time disadvantageously. The light-shielding film described in US 2015/0022894 contains a highly reactive amine curing agent, and therefore the light-shielding film is whitened due to aggregation of titanium oxide.

### SUMMARY OF THE DISCLOSURE

An optical element includes a substrate and a light-shielding film in a part of the substrate, in which the light-shielding film contains a resin and a colorant, and the resin is a cured epoxy resin having a first aryl unit represented by Formula (1) below in a side chain or a terminal.

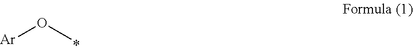

[In the formula, Ar represents a monocyclic unsubstituted aryl group, a polycyclic unsubstituted aryl group, a monocyclic substituted aryl group, or a polycyclic substituted aryl group.]

A light-shielding coating material set for an optical element, includes a unit A containing an epoxy resin and a unit B containing a curing agent, in which the light-shielding coating material set contains a colorant and an organic solvent in the unit A or/and the unit B, and the curing agent has a first aryl unit represented by Formula (1) below.

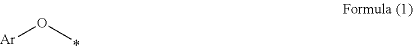

[In the formula, Ar represents a monocyclic unsubstituted aryl group, a polycyclic unsubstituted aryl group, a monocyclic substituted aryl group, or a polycyclic substituted aryl group.]

A method for manufacturing an optical element, includes coating an outer periphery of a substrate with a light-shielding coating material containing at least an epoxy resin, a colorant, and a curing agent having a first unit represented by Formula (1) below,

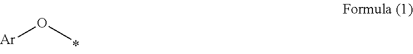

[In the formula, Ar represents a monocyclic unsubstituted aryl group, a polycyclic unsubstituted aryl group, a monocyclic substituted aryl group, or a polycyclic substituted aryl group.], and curing the coating material with which the substrate has been coated at a temperature of 20° C. to 100° C.

Further features of the present disclosure will become apparent from the following description of exemplary embodiments (with reference to the attached drawings).

### BRIEF DESCRIPTION OF THE DRAWINGS

FIG. 1 is a view illustrating an example of the optical element according to an aspect of the present disclosure.

FIG. 2 is a diagram illustrating a mechanism in which the light-shielding film according to an aspect of the present disclosure suppresses elution of a colorant.

FIG. 3 illustrates a hydrolysis reaction of a curing agent having a protected amino group in accordance with one or more embodiments of the present disclosure.

FIG. 4 illustrates a reaction between an amine and a compound having an epoxy group in accordance with one or more embodiments of the present disclosure.

FIG. 5 illustrates a typical example of an epoxy resin in accordance with one or more embodiments of the present disclosure.

FIG. 6A is a schematic view of an optical element provided with a light-shielding film in accordance with one or more embodiments of the present disclosure, and FIG. 6B is a schematic view of an optical element without a light-shielding film in accordance with one or more embodiments of the present disclosure.

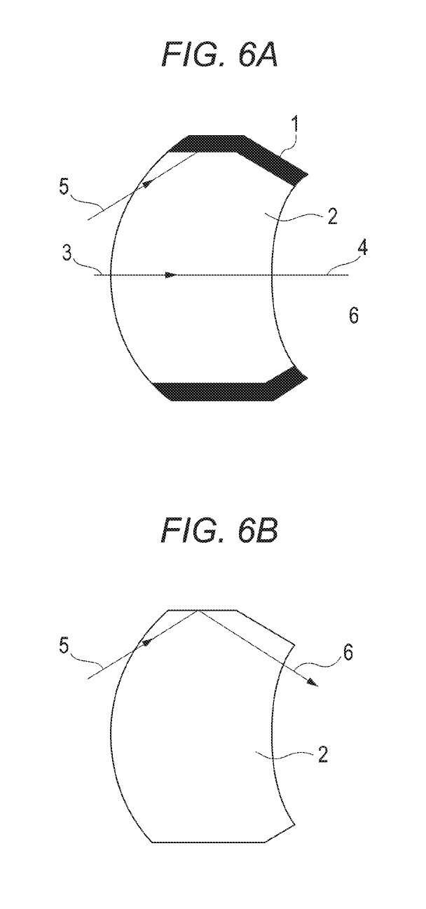

### DESCRIPTION OF THE EMBODIMENTS

Hereinafter, preferable embodiments of the present disclosure will be described.

### Optical Element

An optical element of an aspect of the present disclosure is provided with a light-shielding film in a part (outer periphery) of a substrate. The optical element can be used for an optical apparatus such as a camera, binoculars, a microscope, or a semiconductor exposure apparatus.

Glass, a lens, or a prism is used as a substrate. A difference in the refractive index nd between the substrate and the light-shielding film is preferably 0.0 or more and 0.2 or less in order to reduce inner surface reflection.

An optical element obtained by sticking a plurality of lenses contributes to reducing a weight of an imaging apparatus or improving an image quality. Therefore, it is possible to use a substrate having a resin layer such as an adhesive between glass plates.

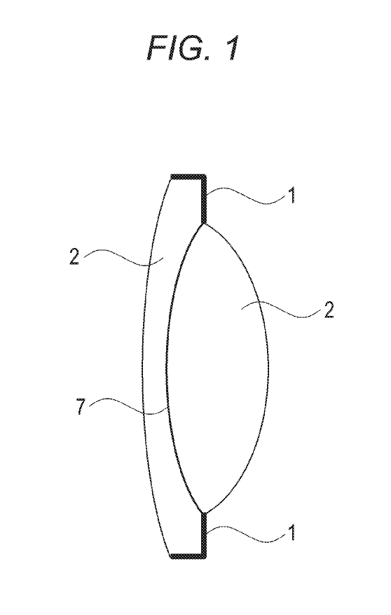

FIG. 1 illustrates an example of an optical element obtained by sticking glass plates with an adhesive. In FIG. 1, two glass lenses 2 are stuck to each other with an adhesive 7, and a light-shielding film 1 is provided in a part of an outer periphery. In FIG. 1, two lenses are stuck to each other, but three or more lenses may be stuck to each other according to a required optical characteristic.

A light-shielding film used in the optical element of an aspect of the present disclosure will be described in detail below.

### Light-Shielding Film

A light-shielding film of an aspect of the present disclosure contains at least a resin and a colorant, and has high solvent resistance. The light-shielding film of an aspect of the present disclosure preferably contains inorganic fine particles in order to reduce a difference in the refractive index between the light-shielding film and a substrate. The light-shielding film of an aspect of the present disclosure can contain an additive within such a range not to deteriorate performance of the light-shielding film.

The light-shielding film of an aspect of the present disclosure preferably has an average film thickness of 2 μm or more and 100 μm or less in order to exhibit a sufficient light-absorbing function. When the film thickness is 2 μm or less, an optical characteristic of the light-shielding film is deteriorated. When the film thickness is 100 μm or more, it is difficult to incorporate an optical element into an imaging apparatus.

### (Resin)

A resin of the light-shielding film of an aspect of the present disclosure is characterized in that a first aryl unit in Formula (1) below is bonded to a cured epoxy resin via a bond*. The first aryl unit is not bonded to a cured epoxy resin in the light-shielding film not via the bond*, and is bonded to a terminal or a side chain of an epoxy resin.

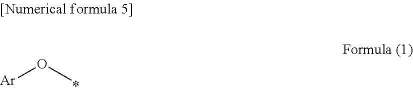

[In the formula, Ar represents a monocyclic unsubstituted aryl group, a polycyclic unsubstituted aryl group, a monocyclic substituted aryl group, or a polycyclic substituted aryl group.]

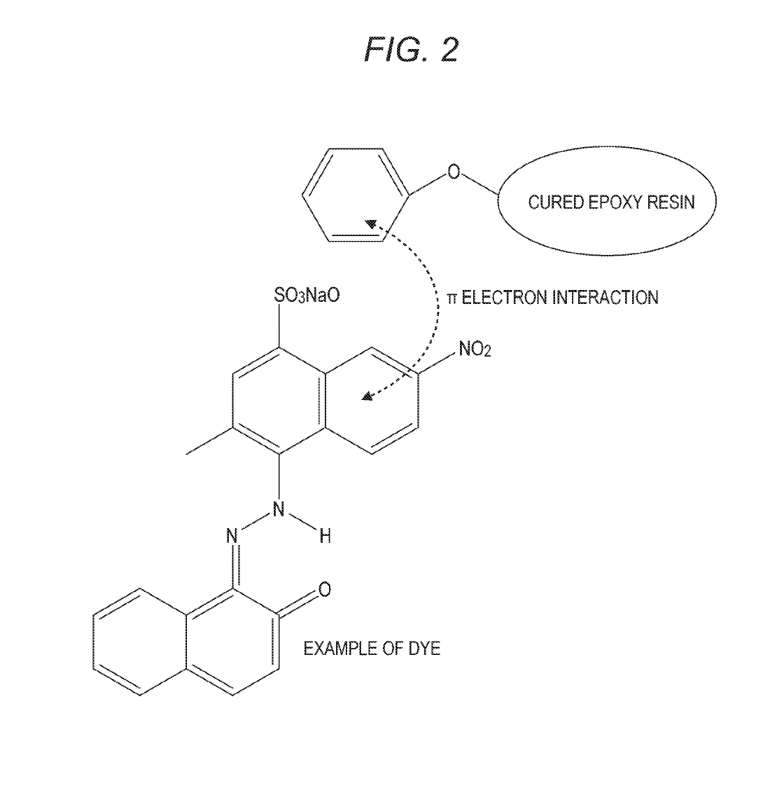

The first aryl unit in Formula (1) contains an aryl group, and therefore has a n electron pair. A colorant contained in the light-shielding film often has an unsaturated bond or an aromatic ring, and as illustrated in FIG. 2, often has a strong interaction with the n electron pair in the first aryl unit in Formula (1). Even when the optical element is cleaned with an organic solvent, the colorant exists stably in a cured epoxy resin due to this interaction, and it is considered that this can suppress elution of the colorant into the organic solvent.

A cured epoxy resin in a resin preferably has a functional group having a polarity. Examples of the functional group having a polarity include —NH—, —NH₂—, —COOH—, and —OH—. When an epoxy resin is cured, by using an amine curing agent, a structure such as —NH— can be introduced into a cured epoxy resin. When the cured epoxy resin has a functional group having a polarity, an interaction occurs between the cured epoxy resin and the colorant, and elution of the colorant can be prevented.

Next, the structure of Ar in Formula (1) will be described more specifically.

Ar in Formula (1) is a monocyclic unsubstituted aryl group, a polycyclic unsubstituted aryl group, a monocyclic substituted aryl group, or a polycyclic substituted aryl group, but is preferably a monocyclic unsubstituted aryl group or a monocyclic substituted aryl group.

Preferably, the resin of the light-shielding film of an aspect of the present disclosure has a monocyclic unsubstituted aryl group in Formula (1) and has a phenyl unit represented by Formula (2) below. The phenyl unit of Formula (2) is not bulky, and therefore does not easily sterically hinder the cured epoxy resin and the colorant in approaching each other, and can suppress elution of the colorant.

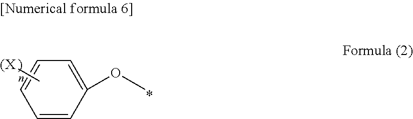

[In the formula, X represents an electron-donating group, and n represents an integer of 0 or more and 5 or less.]

Examples of the monocyclic unsubstituted aryl group include a heterocyclic compound such as thiophene, furan, or pyrrole.

When Ar has a monocyclic substituted aryl group, Ar preferably has an electron-donating substituent in order to strengthen an interaction by a n electron of an aromatic ring. Examples of the polycyclic unsubstituted aryl group include naphthalene and anthracene.

When the aryl group has a substituent, the substituent is particularly preferably an electron-donating group. The electron-donating group is a substituent which is substituted for a hydrogen atom of the aryl group and increases an electron density of the aryl group. Examples thereof include an alkoxy group, an alkyl group, an amino group, a hydroxy group, and an acetoxy group. Among these groups, when an electron-donating group such as —OCH₃—, —OH—, or —NR₂— [in the formula, R represents an alkyl group] is substituted for a hydrogen atom of the aryl group, an electron density is increased, and an interaction with the colorant of an aspect of the present disclosure is enhanced satisfactorily. R in —NR₂— represents an alkyl group, and is preferably a hydrocarbon compound having 1 to 6 carbon atoms particularly in view of availability easiness or the like.

Furthermore, the first aryl unit represented by Formula (1) more preferably has a phenoxy group represented by Formula (3) due to excellent availability easiness and cost.

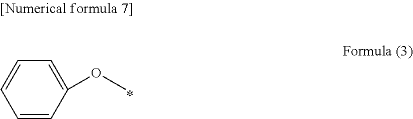

The content of a phenoxy group in an organic component in the cured epoxy resin is preferably 0.5% by mass or more and 25.3% by mass or less. When the content of the phenoxy group is less than 0.5% by mass, an effect of the cured epoxy resin for fixing a colorant is deteriorated. When the content of the phenoxy group is more than 25.3% by mass, the cross-linking density of the cured epoxy resin is lowered, and the solvent resistance of the light-shielding film or a mechanical property may be deteriorated.

The cured epoxy resin may contain an epoxy compound containing a component such as a silane coupling agent in order to improve adhesion to a substrate or affinity with added inorganic fine particles. In the present disclosure, a component of the cured epoxy resin means an organic component other than —Si(OCH₃)₃ contained in a silane coupling agent. It is possible to measure a content of an organic component in the cured epoxy resin in the light-shielding film by measuring a content of an inorganic residue after heating using thermogravimetric analysis.

As a method for quantitative measurement of the content of a phenoxy group, chemical analysis can be used. In the analysis, by immersing a light-shielding film in an organic solvent which can elute a colorant from a film to be subjected to quantitative measurement and removing a component of the colorant by irradiation with ultrasonic waves or heating, it is possible to improve easiness or quantitativity of the analysis. Usually, a monosubstituted aromatic ring of a phenoxy group has a unique structure different from a polysubstituted aromatic ring such as a bisphenol A type epoxy resin contained in a cured epoxy resin. As a specific means of chemical analysis, quantitative measurement can be performed by analyzing a light-shielding by solid carbon nuclear magnetic resonance spectroscopy (C-NMR). Hydrogen nuclear magnetic resonance spectroscopy (H-NMR) and Fourier-transform infrared spectroscopy (FT-IR) can also be used. When H-NMR is used, measurement can be performed in a swelling state using a heavy solvent in which a light-shielding film swells. Also in FT-IR, it is easy to measure a sample in a solid state, and it is possible to measure a light-shielding film on an optical element. The content of a phenoxy group can be measured quantitatively also by a pyrolysis gas chromatography method.

Examples of the epoxy resin in the resin of an aspect of the present disclosure include a bisphenol A type epoxy resin, a bisphenol F type epoxy resin, a multifunctional epoxy resin, a flexible epoxy resin, a brominated epoxy resin, a glycidyl ester epoxy resin, a polymer epoxy resin, and a biphenyl epoxy resin. The epoxy resin may be used singly or in mixture of two or kinds thereof.

### (Colorant)

As a colorant used for the light-shielding coating material of an aspect of the present disclosure, a dye, a pigment, or a mixture thereof can be used. The dye is only required to absorb visible light having a wavelength of 400 nm to 700 nm and to be able to be dissolved in any solvent. The dye may be used singly or in mixture of several kinds of dyes of black, red, yellow, blue, and the like. The pigment is only required to absorb visible light having a wavelength of 400 nm to 700 nm. Examples of the pigment include carbon black, titanium black, and iron oxide. The number average particle diameter of the pigment is preferably 5 nm or more and 200 nm or less. When the number average particle diameter of the pigment is less than 5 nm, stability of a light-shielding coating material is deteriorated. When the number average particle diameter of the pigment is more than 200 nm, inner surface reflection is increased when a light-shielding film is formed. The content of the colorant in the light-shielding coating material of an aspect of the present disclosure is preferably 10.0% by mass or more and 30.0% by mass or less, and more preferably 15.0% by mass or more and 25.0% by mass or less in order to obtain a sufficient light absorption characteristic of a light-shielding film. In order to obtain an average extinction coefficient of a light-shielding film of 0.03 or more, the content of the colorant is preferably 10.0% by mass or more. The content of the colorant is preferably 30% by mass or less in order to prevent deterioration of solvent resistance.

As a light absorption characteristic of a light-shielding film, the average extinction coefficient which is an average value of extinction coefficients of total wavelengths of 400 nm to 700 nm is preferably 0.03 or more and 0.15 or less, and more preferably 0.03 or more and 0.1 or less. When the average extinction coefficient is less than 0.03, reflected light on an interface between a light-shielding film and the air is increased, and a reflection preventing function is thereby deteriorated. When the average extinction coefficient is more than 0.15, reflection on an interface between a lens and a light-shielding film is increased.

Preferable examples of the dye include an azo dye, a quinone dye, a triarylmethane dye, a cyanine dye, a phthalocyanine dye, and an indigo dye. An azo dye and a phthalocyanine dye are particularly preferably used because the azo dye and the phthalocyanine dye have a cyclic structure such as a pyrrole ring, pyridine, or an aromatic ring, a polycyclic structure such as naphthalene or anthracene, an azo group, and an aromatic azo compound. These dyes strongly interact with the first unit in Formula (1) of an aspect of the present disclosure and improve solvent resistance.

Examples of an azo black dye include VALIFAST BLACK 1821 (Orient Chemical Industries Co., Ltd.), VALIFAST BLACK 3810 (Orient Chemical Industries Co., Ltd.), Oil Black HBB (Orient Chemical Industries Co., Ltd.), and Aizen Spilon Black MHS-Liquid (Hodogaya Chemical Co., Ltd.).

Examples of an azo red dye include VALIFAST RED 3320 (Orient Chemical Industries Co., Ltd.) and Aizen Spilon Red BEH S-Liquid (Hodogaya Chemical Co., Ltd.).

Examples of an azo yellow dye include OIL YELLOW 129, VALIFAST YELLOW 3108, and Aizen Spilon Yellow RH S-Liquid (Hodogaya Chemical Co., Ltd.).

Examples of a phthalocyanine blue dye include VALIFAST BLUE 1605 (Orient Chemical Industries Co., Ltd.), VALIFAST BLUE 2670 (Orient Chemical Industries Co., Ltd.), VALIFAST BLUE 2606 (Orient Chemical Industries Co., Ltd.), and VALIFAST BLUE 2620 (Orient Chemical Industries Co., Ltd.).

### (Inorganic Fine Particles)

Inorganic fine particles contained in the light-shielding film of an aspect of the present disclosure are preferably either silica fine particles or inorganic fine particles having a refractive index nd of 2.2 or more, or a mixture thereof. The number average particle diameter of the inorganic fine particles is preferably 5 nm or more and 1000 nm or less, and more preferably 100 nm or less. When the number average particle diameter of the inorganic fine particles is more than 1000 nm, light scattering is significantly caused by inorganic fine particles, and an optical function of the light-shielding film is deteriorated.

Use of silica fine particles makes it possible to form unevenness on a surface of the light-shielding film and to suppress reflection on the surface due to a matting effect. Silica fine particles also have an effect of preventing a coating material from dropping.

Use of inorganic fine particles having a refractive index nd of 2.2 or more makes it possible to obtain a high refractive index of a generated light-shielding film, and therefore reduces inner surface reflection. Examples of the inorganic fine particles having a refractive index nd of 2.2 or more include fine particles of titanium oxide (titania), zirconium oxide (zirconia), aluminum oxide, tantalum oxide, yttrium oxide, cadmium oxide, diamond, strontium titanate, and germanium. Among these inorganic fine particles, inorganic fine particles having a refractive index nd of 2.2 or more and 3.5 or less are preferably used, and inorganic fine particles of titania and/or zirconia are more preferably used. When the refractive index of inorganic fine particles is less than 2.2, increase in the refractive index of the light-shielding film is small. Therefore, a difference in the refractive index between a substrate and the light-shielding film is large, and an effect of suppressing inner surface reflection is small.

The number average particle diameter of the inorganic fine particles having a refractive index nd of 2.2 or more is preferably 10 nm or more and 100 nm or less, and more preferably 10 nm or more and 20 nm or less. The number average particle diameter of the inorganic fine particles having a refractive index nd of 2.2 or more is preferably as small as possible. However, it is practically difficult to disperse the inorganic fine particles so as to have a diameter of 10 nm or less. When the number average particle diameter of the inorganic fine particles is larger than 100 nm, scattering occurs easily. The number average particle diameter of the inorganic fine particles is used as an actual size of a particle existing in the light-shielding film. For example, when the inorganic fine particles are agglomerated, the number average particle diameter of the inorganic fine particles is used as a size of a particle obtained by the aggregation.

The content of the inorganic fine particles in the light-shielding film of an aspect of the present disclosure is preferably 5.0% by mass or more and 40.0% by mass or less, and more preferably 10.0% by mass or more and 15.0% by mass or less.

When the content of the inorganic fine particles in the light-shielding film of an aspect of the present disclosure is less than 10.0% by mass, increase in the refractive index is small, and inner surface reflection is increased. When the content of the inorganic fine particles in the light-shielding film of an aspect of the present disclosure is larger than 40.0% by mass, an adhesive force or durability of a coating film is reduced, and therefore the content of larger than 40.0% by mass is not preferable.

### (Additive)

The light-shielding film of an aspect of the present disclosure may contain an additive in a range in which performance of the light-shielding film is not deteriorated. Examples of the additive include an antifungal agent and an oxidation inhibitor. The content of the additive in the light-shielding film is preferably 15.0% by mass or less, and more preferably 10.0% by mass or less.

### Light-Shielding Coating Material

Next, a material composition of the light-shielding coating material of an aspect of the present disclosure will be described. Hereinafter, unless otherwise specified, the content of a material used for the light-shielding coating material means a content with respect to a light-shielding coating material containing a curing agent.

The light-shielding coating material of an aspect of the present disclosure contains an epoxy resin, a colorant, and a curing agent. The light-shielding coating material preferably contains inorganic fine particles such that the light-shielding film reduces inner surface reflection.

### (Resin)

The light-shielding coating material of an aspect of the present disclosure contains a resin described in the above light-shielding film.

The content of an epoxy resin contained in the light-shielding coating material of an aspect of the present disclosure is preferably 5.0% by mass or more and 25.0% by mass or less with respect to the light-shielding coating material. When the content of an epoxy resin is less than 5.0% by mass, the content of a resin component in the light-shielding coating material is small, and therefore solvent resistance is deteriorated. When the content of an epoxy resin is more than 25.0% by mass, the refractive index is reduced, inner surface reflection is therefore increased, cloudiness occurs due to reduction in compatibility between the resin and inorganic fine particles, and scattering occurs easily.

The content of an epoxy resin in the light-shielding coating material of an aspect of the present disclosure is preferably 0.5% by mass or more and 15.0% by mass or less in the light-shielding coating material. When the content of an epoxy resin is less than 0.5% by mass, adhesion to a substrate is reduced when a light-shielding film is formed. When the content of an epoxy resin is more than 15.0% by mass, adhesion to a substrate is reduced when a light-shielding film is formed. Examples of a coupling agent having an epoxy group include a commercially available silane coupling agent having an epoxy group and a synthesized silane coupling agent. Examples of the silane coupling agent include 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, and 3-glycidoxypropyltriethoxysilane.

### (Colorant)

As a colorant used for the light-shielding coating material of an aspect of the present disclosure, the colorant described in the light-shielding film can be used.

The content of the colorant contained in the light-shielding coating material of an aspect of the present disclosure is preferably 2.5% by mass or more and 15.0% by mass or less, and more preferably 5.0% by mass or more and 7.5% by mass or less.

### (Inorganic Fine Particles)

As inorganic fine particles used for the light-shielding coating material of an aspect of the present disclosure, the inorganic fine particles described in the light-shielding film can be used.

The content of the inorganic fine particles contained in the light-shielding coating material of an aspect of the present disclosure is preferably 2.5% by mass or more and 20.0% by mass or less, and more preferably 5.0% by mass or more and 7.5% by mass or less. When the content is less than 2.5% by mass, increase in the refractive index is small, and inner surface reflection is increased. When the content is more than 20.0% by mass, an adhesive force or durability of a coating film is reduced.

### (Curing Agent)

The light-shielding coating material of an aspect of the present disclosure contains a curing agent in order to cure an epoxy resin contained in the light-shielding coating material. Examples of the curing agent include a curing agent which can polymerize an epoxy resin, such as an amine, an acid anhydride, or an acid generator. Particularly, an amine curing agent is more preferable due to having reactivity even at normal temperature.

As a curing agent of the light-shielding coating material of an aspect of the present disclosure, a curing agent having a first unit described in Formula (1) below is used because the curing agent can prevent elution of the colorant in the light-shielding film.

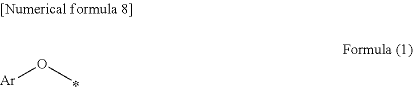

[In the formula, Ar represents a monocyclic unsubstituted aryl group, a polycyclic unsubstituted aryl group, a monocyclic substituted aryl group, or a polycyclic substituted aryl group.]

Among curing agents having the first aryl unit described in Formula (1), the curing agent of the light-shielding coating material preferably has a phenyl unit represented by Formula (2) below.

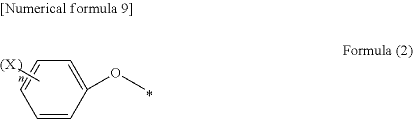

[In the formula, X represents an electron-donating group, and n represents an integer of 0 or more and 5 or less.]

Among the curing agents having the first aryl unit described in Formula (1), the curing agent of the light-shielding coating material preferably has a phenoxy group represented by Formula (3). By using the curing agent having a phenoxy group, it is possible to easily introduce a phenoxy group into various epoxy resins.

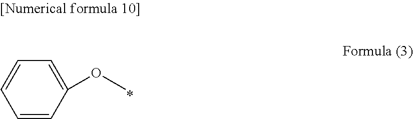

The curing agent having a phenoxy group can be obtained easily by a reaction between an epoxy group and an amine having a phenoxy group by a known method. Preferable examples of a compound having an epoxy group and a phenoxy group include glycidyl phenyl ether due to easy availability. The curing agent having a phenoxy group is obtained by a reaction between an epoxy group and an amino group of an amine. Therefore, at the time of synthesis, it is necessary to make an unreacted amino group remain by making the molar number of the epoxy group insufficient with respect to the amino group. Therefore, a molar compounding ratio at the time of synthesis (amino group: epoxy group) is preferably 10:1 or more and 1.1:1 or less. Examples of an amino compound used for the synthesis include a straight chain aliphatic amino compound, a polyamide amino compound, an alicyclic amino compound, an aromatic amino compound, and an addition polymer of dicyandiamide, adipic dihydrazide, ethylene oxide having an amino group at a terminal, or propylene oxide. Among these amines, an amine having three or more amino groups is preferable in order to introduce a phenoxy group into the curing agent while an amino group remains.

The curing agent of the light-shielding coating material of an aspect of the present disclosure preferably has a second unit represented by Formula (4) below.

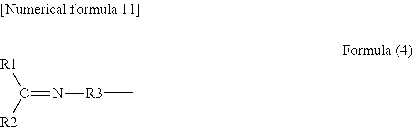

[In the formula, each of R1 and R2 represents a hydrogen atom or an alkyl group having 1 to 8 carbon atoms, and R3 represents an alkyl chain or an aromatic ring having 1 to 8 carbon atoms.]

A compound having such a structure is generally referred to as a ketimine compound. An amino group of an aliphatic amine or an aromatic amine is preferably protected as in Formula (4) such that a curing agent functions suitably after hydrolysis as the curing agent of an aspect of the present disclosure.

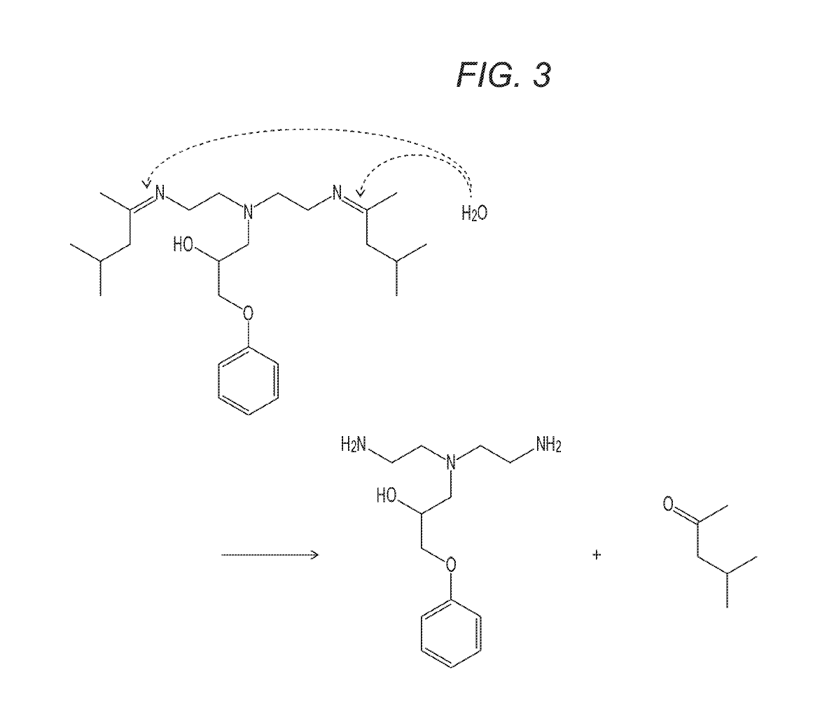

In the curing agent represented by Formula (4), an active amino group is protected. Therefore, even when a light-shielding coating material contains inorganic particles, it is possible to prevent light scattering of a light-shielding film caused by aggregation of the inorganic particles due to interaction with the inorganic particles. The curing agent represented by Formula (4) is hydrolyzed by existence of moisture to generate an active amino group. FIG. 3 illustrates a hydrolysis reaction of an example of a curing agent satisfying Formula (4). By being hydrolyzed by moisture in a light-shielding coating material or the air, the curing agent represented by Formula (4) generates an amino group gradually in the light-shielding coating material or the light-shielding film, contributes to a polymerization reaction of a compound having an epoxy group, and can accelerate formation of an excellent light-shielding film.

The curing agent represented by Formula (4) can be introduced into an amine by subjecting an aldehyde or a ketone and an amino group of an amine to dehydration condensation by a known method. Examples of the aldehyde include formaldehyde, acetaldehyde, propionaldehyde, butanal, and pentanal. Examples of the ketone include acetone, methyl ethyl ketone, diethyl ketone, methyl propyl ketone, methyl isobutyl ketone, methyl amyl ketone, and cyclohexanone. In the curing agent represented by Formula (4), obtained by a reaction between these substances and an amino group, R1 and R2 are each preferably a hydrogen atom or an alkyl group having 1 to 8 carbon atoms in terms of availability easiness of an aldehyde or a ketone and cost. The alkyl group may be branched or linear. Particularly methyl ethyl ketone can be preferably used because R1 is CH₃, R2 is C₂H₅ in a case of a reaction between methyl ethyl ketone and an amino group, methyl ethyl ketone is easily available, and the rate of hydrolysis is appropriate for curing around room temperature.

The curing agent having a phenoxy group represented by Formula (3), the curing agent represented by Formula (4), and another amine curing agent can be used singly or in combination of two or kinds thereof.

The content of an amine curing agent contained in the light-shielding coating material of an aspect of the present disclosure is preferably 0.5% by mass or more and 13.0% by mass or less in the light-shielding coating material. When the content of the amine curing agent is less than 0.5% by mass, hardness of the light-shielding film is reduced, and adhesion of the light-shielding film to a substrate is reduced. When the content of the amine curing agent is more than 13.0% by mass, an optical characteristic is deteriorated. The addition amount of the amine curing agent has an upper limit. Therefore, in order to sufficiently obtain the effect of the present disclosure, the curing agent having structures of both Formulae (3) and (4) described above is preferable. Examples of the curing agent having structures of both Formulae (3) and (4) include jER CURE H3 (registered trademark) and jER CURE H30 (registered trademark), manufactured by Mitsubishi Chemical Corporation, preferably used in the present disclosure.

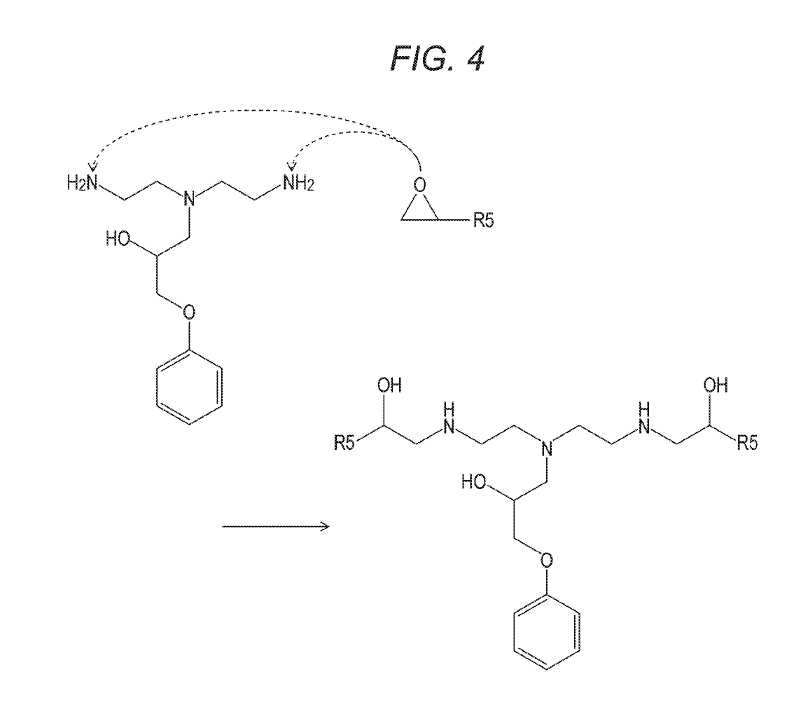

FIG. 4 illustrates an example of hydrolysis of a curing agent which has a phenoxy group and has an amino group protected. The amine curing agent in FIG. 4 is a compound obtained by a reaction between a part of an amino group and glycidyl phenyl ether while an amino group in diethylenetriamine is protected by methyl isobutyl ketone. This amine curing agent reacts with water in the light-shielding coating material or the light-shielding film. Methyl isobutyl ketone is thereby eliminated from an amino group to generate a compound having both an amino group and a phenoxy group.

A primary amine contained in the produced compound having an amino group and a phenoxy group reacts with a compound having an epoxy group as illustrated in FIG. 2. A cured epoxy resin having a phenoxy group is thereby obtained. A secondary amine generated by the reaction further reacts with an epoxy group to generate a tertiary amine. The generated tertiary amine is polymerized with an epoxy group. A cured epoxy resin having a phenoxy group is obtained through these reactions.

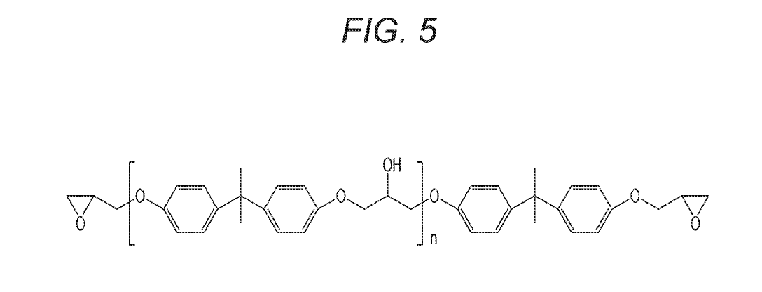

R5 in FIG. 4 represents a main chain skeleton of a compound having an epoxy group. R5 may have a plurality of epoxy groups in addition to the epoxy group illustrated in FIG. 4. Typical examples of an epoxy resin include an epichlorohydrin condensate of bisphenol A as illustrated in FIG. 5. Examples thereof include jER CURE 828 (registered trademark) manufactured by Mitsubishi Chemical Corporation. n in FIG. 5 represents any integer.

By using the light-shielding coating material containing a curing agent which has a phenoxy group and has an amino group protected and the compound having an epoxy group, it is possible to easily form a light-shielding film containing a cured epoxy resin having a phenoxy group.

### (Organic Solvent)

The light-shielding coating material of an aspect of the present disclosure preferably contains an organic solvent due to being able to adjust a viscosity. The organic solvent used for the light-shielding coating material of an aspect of the present disclosure is not particularly limited as long as the organic solvent satisfies dispersibility of inorganic fine particles and solubility of a compound having an epoxy group, a colorant, and an amine curing agent. Examples of the organic solvent include propylene glycol monomethyl ether, propylene glycol monomethyl ether acetate, methyl ethyl ketone, methyl isobutyl ketone, xylene, toluene, isopropyl alcohol, acetone, and ethanol. These organic solvents may be used singly or in mixture of two or kinds thereof.

The viscosity of the light-shielding coating material is preferably 10 mPa·s or more and 1000 mPa·s or less. When the viscosity of the light-shielding coating material is less than 10 mPa·s, coatability of the light-shielding coating material is deteriorated. When the viscosity is more than 1000 mPa·s, the light-shielding film may have a part having a large thickness after coating.

### (Additive)

The light-shielding coating material of an aspect of the present disclosure may contain a curing catalyst such as a tertiary amine or am imidazole compound, and another additive. Examples of the other additive include an antifungal agent and an oxidation inhibitor.

The content of an additive contained in the light-shielding coating material of an aspect of the present disclosure is preferably 5.0% by mass or less, and more preferably 3.0% by mass or less.

### Light-Shielding Coating Material Set

The light-shielding coating material set of an aspect of the present disclosure includes at least a unit A containing an epoxy resin and a unit B containing the above curing agent, and includes two or more units. By mixing all the units, the above light-shielding coating material is obtained.

In the light-shielding coating material of an aspect of the present disclosure, the unit A containing an epoxy resin and the unit B containing a curing agent are separated. Therefore, the light-shielding coating material of an aspect of the present disclosure has an excellent storage property and is preferable. Any one unit or a plurality of units contains a colorant. Therefore, the unit A containing an epoxy resin, the unit B containing a curing agent, or a unit other than these units contains a colorant.

By mixing and dispersing materials contained in all the units described above, the light-shielding coating material of an aspect of the present disclosure can be obtained. As a mixing and dispersing method, stirring can be performed using a ball mill, a bead mill, a collision dispersion apparatus, a planetary rotation stirring apparatus, a homogenizer, or a stirrer. As a dispersing method, stirring can be performed using a ball mill, a bead mill, a collision dispersion apparatus, a planetary rotation stirring apparatus, a homogenizer, or a stirrer.

### Method for Manufacturing Light-Shielding Film

Next, a method for manufacturing a light-shielding film of an aspect of the present disclosure will be described.

In the method for manufacturing a light-shielding film of an aspect of the present disclosure, the above light-shielding coating material is cured to manufacture a light-shielding film. The method for manufacturing a light-shielding film of an aspect of the present disclosure includes a process of coating a substrate with a light-shielding coating material containing an epoxy resin, a colorant, and the above curing agent and a process of curing the light-shielding coating material with which the substrate has been coated at a temperature of 20 to 150° C. The light-shielding coating material used contains a curing agent having a structure represented by Formula (1).

In the process of coating a substrate with a light-shielding coating material, coating is preferably performed after the light-shielding coating material is dispersed by any dispersing method. As a dispersing method, stirring can be performed using a ball mill, a bead mill, a collision dispersion apparatus, a planetary rotation stirring apparatus, a homogenizer, or a stirrer.

In the process of curing a light-shielding coating material, the light-shielding coating material with which the substrate has been coated is cured at a temperature of 20° C. or higher and 150° C. or lower, but is preferably cured at a temperature of 20° C. or higher and 100° C. or lower. When curing is performed at a temperature of lower than 20° C., progress of a polymerization reaction of an epoxy resin is lowered, a cross-linking density is thereby insufficient, and solvent resistance is deteriorated. When the light-shielding coating material of an aspect of the present disclosure is cured at a temperature of higher than 150° C., a cured epoxy resin or a colorant is deteriorated, and a function as a light-shielding film is deteriorated.

A light-shielding coating material used in the method for manufacturing a light-shielding film of an aspect of the present disclosure preferably satisfies the above requirements of materials, conditions, and the like.

A light-shielding film formed using the light-shielding coating material of an aspect of the present disclosure has high solvent resistance, and therefore can be used suitably for a lens requiring a cleaning process with an organic solvent such as isopropyl alcohol in a manufacturing process.

When a high temperature is applied to a cemented lens obtained by sticking glass lenses to each other in forming a light-shielding film, an interface between an adhesive resin layer used for cementing lenses and a glass lens is peeled due to a difference in heat expansion between the adhesive resin layer and the glass lens. The light-shielding coating material of an aspect of the present disclosure can form a light-shielding film at a low temperature, and therefore can be suitably used for the cemented lens obtained by sticking glass lenses to each other.

Similarly, when a high temperature is applied to a plastic lens in forming a light-shielding film, the plastic lens causes distortion of a shape due to heat and deteriorates an optical property of a lens. The light-shielding coating material of an aspect of the present disclosure can form a light-shielding film at a low temperature, and therefore can be suitably used for the plastic lens.

### Method for Manufacturing Optical Element

Next, a method for manufacturing an optical element of an aspect of the present disclosure will be described.

The method for manufacturing an optical element of an aspect of the present disclosure is a method for manufacturing an optical element in which a light-shielding film is provided on a surface of an outer periphery of a substrate formed of an optical material. The method for manufacturing an optical element of an aspect of the present disclosure includes a process of coating a surface of an outer periphery of a substrate with a light-shielding coating material containing a compound having an epoxy group, inorganic fine particles, a colorant, and a curing agent, and a process of curing the coating material with which the substrate has been coated in an atmosphere at a temperature of 20° C. or higher and 100° C. or lower. The light-shielding coating material used contains a curing agent having a structure represented by Formula (1).

Examples of the substrate formed of an optical material include a lens and a prism. A difference in the refractive index nd between the optical material and the light-shielding film is preferably 0.0 or more and 0.2 or less in order to reduce inner surface reflection. An optical element obtained by sticking a plurality of lenses to each other contributes to reducing a weight of an imaging apparatus or improving an image quality. Therefore, the substrate of an aspect of the present disclosure more preferably has a resin layer between glass plates.

The method for manufacturing an optical element of an aspect of the present disclosure preferably satisfies the conditions and the like described in the above method for manufacturing a light-shielding film.

### EXAMPLES

Hereinafter, preferable Examples in the present disclosure will be described.

In Examples and Comparative Examples below, preparation of a light-shielding coating material, manufacturing a light-shielding film, and evaluation of an optical characteristic and an appearance were performed by the following methods.

### <Evaluation Method>

In Examples of the present disclosure, the following evaluation methods were used.

### Method for Evaluating Elution of Colorant

Elution of a colorant was evaluated by the following method. First, a light-shielding film was formed so as to have a predetermined thickness on any kind of glass having a diameter (0 of 30 mm according to a formation method of a light-shielding film in each Example. The obtained light-shielding film was immersed in an isopropyl alcohol (hereinafter, referred to as IPA) solution for ten minutes, and presence of coloring of IPA was observed. A indicates a light-shielding film having excellent solvent resistance. B and C indicate a light-shielding film having good solvent resistance. D indicates a light-shielding film having poor solvent resistance.

A: No coloring of IPA was observed.

B: Coloring of IPA was slightly observed, but the color tone of a coating film was not changed.

C: Coloring of IPA was observed, but the color tone of a coating film was not changed.

D: Coloring of IPA was observed, and the color tone of a coating film was changed.

### Method for Evaluating Environmental Stability (the Number of White Points After a Sample is Allowed to Stand at High Temperature and High Humidity)

Environmental stability (the number of white points after a sample was allowed to stand at a high temperature and a high humidity) was evaluated as follows. For measurement, glass subjected to frost processing at # 240, having a diameter of 30 mm and a thickness of 1 mm, and made of S-LAL 18 was used. First, a frost-processed surface of the glass was coated with a light-shielding coating material using a sponge so as to have a predetermined thickness, and the light-shielding coating material was cured according to the above method for manufacturing a light-shielding film. Subsequently, the cured product was allowed to stand in a furnace at an atmosphere temperature of 60° C. and a humidity of 90% for 250 hours to obtain a sample for evaluating a white point. The sample for evaluating a white point was photographed with a microscope. The number of white points having a diameter of 0.02 mm or more was counted in a photographed image of 6 mm². The number of white points generated was evaluated based on the following standard. A indicates a light-shielding film having a particularly excellent appearance. B indicates a light-shielding film having a good appearance. C indicates a light-shielding film having a deteriorated appearance.

A: The number of white points having a diameter of 0.02 mm or more was 40 or less in an image of 6 mm².

B: The number of white points having a diameter of 0.02 mm or more was 41 to 100 in an image of 6 mm².

C: The number of white points having a diameter of 0.02 mm or more was 101 or more in an image of 6 mm².

### Method for Measuring Average Extinction Coefficient

A sample for measuring an average extinction coefficient was manufactured by forming a light-shielding film for an optical element on flat plate glass. Flat plate glass having a width of 20 mm, a length of 50 mm, and a thickness of 1 mm was used. A light-shielding film for an optical element was formed on an upper surface of the flat plate glass. The film thickness of the light-shielding film for an optical element at this time was adjusted to 1 μm. Next, a transmittance was measured using a spectrophotometer (U-4000 manufactured by Hitachi High-Technologies Corporation). A sample for measuring an extinction coefficient, in which a light-shielding film has been formed, was set, and the transmittance was measured at an interval of 1 nm at wavelengths of 400 nm to 700 nm in a region of visible light assuming the transmittance of the flat plate glass to be 100%. The average transmittance of the sample for measuring an extinction coefficient at wavelengths of 400 nm to 700 nm was calculated by dividing the total of the obtained transmittances at wavelengths of 400 nm to 700 nm by the data number of 300.

The extinction coefficient was calculated according to Formulae (5), (6), and (7) after an average transmittance I was measured using the spectrophotometer. The sign OD in Formula (5) represents an absorbance, and a numerical value obtained by dividing the average transmittance I by I₀ representing the transmittance 100% and calculating −log thereof. The absorption coefficient a in Formula (6) represents an amount of light absorption per unit length, obtained by dividing the absorbance OD by a thickness L of a light-shielding film. The extinction coefficient k in Formula (7) represents a value obtained by multiplying the absorption coefficient a with a wavelength λ in order to make the absorption coefficient α dimensionless.

OD=−log(I/I₀) Formula (5)

α=2.303×OD/L Formula (6)

k=α×λ/4n Formula (7)

When the average extinction coefficient of a sample, determined by the calculation, was 0.03 or more and 0.15 or less, the sample was evaluated as A, and a sample having an average extinction coefficient outside this range was evaluated as B.

### Method for Evaluating Scattering

Scattering was evaluated by irradiation of light from an irradiator at an intensity of 60 W. A triangular prism was used as a sample for measurement. In the triangular prism used, the length of one of the sides forming a right angle was 30 mm, the thickness was 10 mm, and the material was S-LAH53 (nd=1.805). A light-shielding film was formed on a bottom face of the triangular prism, the formed light-shielding film was irradiated with light, and reflected light was observed visually. As an observation item, a color tone caused by scattering of light was evaluated mainly. A light-shielding film having little scattering and exhibiting an excellent color tone as a light-shielding film was evaluated as A. A light-shielding film exhibiting whiteness but having no problem as a light-shielding film was evaluated as B. A light-shielding film having a whitened color tone due to scattered light was evaluated as C.

### Quantitative Measurement of Phenoxy Group

In a light-shielding film, quantitative measurement of a phenoxy group contained in an organic component in a cured epoxy resin was performed by the following method.

A light-shielding film formed on a glass substrate was immersed in N,N-dimethylformamide (DMF), and was subjected to ultrasonic cleaning. DMF in which the light-shielding film was immersed was replaced three times, and ultrasonic cleaning was performed repeatedly. A colorant was eluted into DMF, and an almost transparent light-shielding film was obtained. The obtained light-shielding film was separated from the glass substrate, was ground by a mortar to obtain powder, and light-shielding film powder was thereby obtained.

Using the light-shielding film powder as a sample, analysis was performed by solid nuclear magnetic resonance spectroscopy (NMR) and thermogravimetric analysis (TGA) to obtain a content (% by mass) of a phenoxy group in an organic component of the light-shielding film.

Using the light-shielding film powder as a sample, the sample was heated to a temperature of 900° C. in an atmosphere of oxygen in thermogravimetric analysis (TGA), and a content of an inorganic residue was calculated. A ratio of an organic component in a cured epoxy resin was calculated using a reduced mass due to heating.

A MAS rotor for solid NMR made of zirconia oxide was weighed, and then the obtained light-shielding film powder was packed thereinto as a sample until about a half of the rotor was filled with the powder. Hexamethylcyclotrisiloxane (6 mg) was precisely weighed, cut out, and was put into the rotor. The sample was further packed thereinto, and the whole rotor was weighed. A sample amount in the rotor was determined by subtracting a rotor mass and a silicon rubber mass therefrom. The sample amount was about 80 mg.

After weighing, measurement was performed using Avance III 400 MHz NMR (manufactured by Bruker Corporation).

As a result of the measurement, a signal assigned to a phenoxy group contained in the sample and a signal assigned to a methyl group of hexamethylcyclotrisiloxane were confirmed. By assuming the signal assigned to a methyl group of hexamethylcyclotrisiloxane to be 1, an integral ratio of an observed peak assigned to a carbon atom in an aromatic ring of a phenoxy group was calculated.

The molar number of hexamethylcyclotrisiloxane in the sample was calculated from the mass of hexamethylcyclotrisiloxane put into the rotor. The carbon number of hexamethylcyclotrisiloxane is six, and the carbon number of an aromatic ring of a phenoxy group is five. An integral ratio calculated from this ratio was corrected, the molar number of a phenoxy group contained in the rotor was calculated, and a mass thereof was determined.

The mass of an organic component in the sample put into the rotor was determined by calculation using a ratio of an organic component of a cured epoxy resin determined by TGA.

The content (% by mass) of a phenoxy group contained in an organic component in a cured epoxy resin was determined from the mass of the organic component in the sample put into the rotor and the mass of the phenoxy group.

### Example 1

A light-shielding coating material in Example 1 was manufactured by the following method.

### <Preparation of Light-Shielding Coating Material>

A slurry of inorganic fine particles was manufactured by the following procedures. A dispersant, 600 g of propylene glycol monomethyl ether, and 150 g of titania fine particles (titanium oxide MT-05; Tayca Corporation) having a refractive index (nd) of 2.2 or more were dispersed using beads of Φ 50 μm in a bead mill (ultra apex mill; Kotobuki Industries Co., Ltd.) for six hours. 600 g of a slurry of titania fine particles having a number average particle diameter of 20 nm was obtained.

Next, 421 g of the slurry of titania fine particles, 74 g of an epoxy resin, 125 g of a coupling agent, 330 g of propylene glycol monomethyl ether, and 48 g of an organic dye were each weighed and were put into a ball mill pot. Subsequently, five magnetic balls having a diameter of 20 mm were put into the ball mill pot. As the epoxy resin, a polycondensate of 4,4′-isopropylidenediphenol and 1-chloro-2,3-epoxypropane having a structural formula in FIG. 5 (jER CURE 828 (registered trademark), manufactured by Mitsubishi Chemical Corporation, active hydrogen equivalent: 189 g/eq) was used. As the coupling agent, an epoxy silane coupling agent (KBM-403 (trade name) manufactured by Shin-Etsu Chemical Co., Ltd., active hydrogen equivalent: 236 g/eq) was used. The ball mill pot including the mixed coating material and the magnetic balls was set into a roll coater, and stirred at 66 rpm for 48 hours to obtain a light-shielding coating material in Example 1.

For the organic dye, a black dye, a red dye, a yellow dye, and a blue dye were mixed to be used. The following dyes were used as the dye. As the organic dye in Examples of the present disclosure, a dye having a color dye mixing ratio of a red dye: 33% by mass, a yellow dye: 13% by mass, a black dye: 13% by mass, and a blue dye: 41% by mass, was used. An amount of the organic dye added to the light-shielding coating material was adjusted such that the content of the organic dye in an obtained light-shielding film was an amount indicated in Table 1. An amount of the dye added to the light-shielding coating material was adjusted by changing mixing amounts of propylene glycol monomethyl ether and the organic dye. When the content of the organic dye in the light-shielding film was 25% by mass or more, the amount of a solvent in the light-shielding coating material is small and handling is difficult. Therefore, propylene glycol monomethyl ether as an organic solvent was added such that the total amount of the light-shielding coating material was 65 g to be mixed.

As a black dye, VALIFAST BLACK 1821 (Orient Chemical Industries Co., Ltd.) was used.

As a red dye, VALIFAST RED 3320 (Orient Chemical Industries Co., Ltd.) was used.

As a yellow dye, OIL YELLOW 129 and VALIFAST YELLOW 3108 were used.

As a blue dye, VALIFAST BLUE 1605 (Orient Chemical Industries Co., Ltd.) was used.

### <Manufacturing Light-Shielding Film>

In Example 1, a light-shielding film was manufactured by the following method. As a light-shielding coating material/curing agent solution, 4.9 g of an amine curing agent A was added to 50 g of the light-shielding coating material, and the resulting mixture was stirred with a roll coater for ten minutes. The amine curing agent A (jER CURE H30 (registered trademark) manufactured by Mitsubishi Chemical Corporation, active hydrogen equivalent: 107 g/eq) was used. A stirring condition of the roll coater was 66 rpm.

A glass substrate or a lens for evaluation was coated with the obtained light-shielding coating material/curing agent solution at a predetermined thickness, and was dried at room temperature for 60 minutes. After being dried, the light-shielding coating material was cured in a thermostatic furnace at a temperature of 40° C. for eight hours to obtain a light-shielding film in Example 1.

The obtained light-shielding film was evaluated. In Example 1, elution of a colorant was evaluated as A, environmental stability was evaluated as A, an optical characteristic (extinction coefficient) was evaluated as A, and an optical characteristic (scattering) was evaluated as A. The content of a dye in the light-shielding film was 20% by mass.

From an epoxy equivalent of an epoxy resin 189 g/eq, a mass thereof 3.70 g in 50 g of the light-shielding coating material, an epoxy equivalent of a coupling agent 236 g/eq, and a mass thereof 6.28 g in 50 g of the light-shielding coating material, a ratio (e′/e) between an epoxy equivalent (e) of a compound having an epoxy group and a mass (e′) of the compound having an epoxy group was calculated. e′/e=0.020+0.027=0.047. The active hydrogen equivalent of the amine curing agent A was 107 g/eq. From an active hydrogen equivalent a of 4.9 g of the amine curing agent A and a mass a′ of the amine curing agent, a′/a=0.046. Therefore, a mixing equivalent ratio (a′/a)/(e′/e) of an amine curing agent in Example 1 was 1.0. A mixing equivalent of an amine curing agent in cases other than Example 1 was similarly calculated.

The used amine curing agent A has one phenoxy group in one molecule of the curing agent (molecular weight: 253), has two amino groups protected by methyl isobutyl ketone (MIBK) in the molecule, and has a structure of Formula (4). From the composition of the light-shielding coating material, the content (excluding an inorganic component) of the compound having an epoxy group in the light-shielding film and the content of the amine curing agent A after MIBK in the light-shielding film is hydrolyzed are calculated.

From these contents, using the following formula, a theoretical content (% by mass) of a phenoxy group contained in an organic component of a cured epoxy resin can be determined. In Tables, this value is described as “content (% by mass) of phenoxy group contained in organic component of cured epoxy resin”.

content (% by mass) of phenoxy group contained in organic component of cured epoxy resin=content of phenoxy group in amine curing agent A/(content of compound having epoxy group+content of amine curing agent A after hydrolysis)×100

The light-shielding film in Example 1 was subjected to quantitative measurement of a phenoxy group (% by mass) contained in an organic component of a cured epoxy resin. The content of a phenoxy group was 11.3% by mass, which was in good agreement with a theoretical value determined from raw materials.

### Examples 2 to 34

Light-shielding coating materials in Examples 2 to 34 were manufactured in a similar manner to Example 1 except that the compositions were changed to those indicated in Tables 1 to 3. The mixing amounts in a light-shielding coating material in manufacturing are indicated in Tables 1 to 3. The amount of a colorant added was adjusted such that the content of the colorant in a light-shielding film was the amount indicated in Table 1.

When titania fine particles were used as inorganic fine particles, a slurry was manufactured in a similar manner to Example 1. When zirconia fine particles in Example 15 were used, a zirconia slurry was manufactured in a similar manner by changing the titania fine particles in manufacturing the slurry to zirconia fine particles (zirconia oxide manufactured by Sumitomo Osaka Cement Co., Ltd.).

Example 16 was similar to Example 1. However, in Example 16, silica fine particles (NIPSIL E-220A manufactured by Tosoh Silica Corporation) were added to a light-shielding film such that the content thereof was 10% by mass in addition to titania fine particles.

In Example 18, by changing the titania fine particles in Example 1 to titania fine particles SJR-405 manufactured by Tayca Corporation, a titania slurry was manufactured in a similar manner.

A light-shielding coating material/curing agent solution in each Example was manufactured in a similar manner to Example 1. The kind and amount of an amine curing agent used in manufacturing are indicated in Tables 1 to 3. As an amine curing agent which has a phenoxy group and has a structure of Formula (4) by protecting a primary amino group with MIBK, the amine curing agent A (jER CURE H30 (registered trademark) manufactured by Mitsubishi Chemical Corporation) and an amine curing agent B (jER CURE H3 (registered trademark) manufactured by Mitsubishi Chemical Corporation, active hydrogen equivalent: 104 g/eq) were used.

In Example 17, the amine curing agent A was added to a light-shielding coating material GT-7 (manufactured by Canon Chemicals Inc.) obtained by mixing a colorant such as coal tar to an epoxy resin such that the equivalent was 1.0 to manufacture a light-shielding film.

In Example 35, a light-shielding coating material was manufactured in a similar manner to Example 1. To 50 g of the light-shielding coating material, 4 g of glycidyl phenyl ether (manufactured by Tokyo Chemical Industry Co., Ltd., active hydrogen equivalent: 150 g/eq) was added as a compound having both a phenoxy group and an epoxy group. After addition, the resulting mixture was stirred by a roll coater for ten minutes. Thereafter, an amine curing agent C (Adeka hardner EH-6019, manufactured by Adeka Corporation, active hydrogen equivalent: 80 g/eq, an aliphatic amine curing agent which has no phenoxy group and has an amino group not protected) was added, and the resulting mixture was further stirred by a roll coater for ten minutes.

In Example 36, a light-shielding coating material was manufactured in a similar manner to Example 1. To 50 g of the light-shielding coating material, 2.5 g of glycidyl-2-methoxyphenyl ether (manufactured by Tokyo Chemical Industry Co., Ltd., active hydrogen equivalent: 180 g/eq) was added as a compound having both a phenoxy group and an epoxy group. After addition, the resulting mixture was stirred by a roll coater for ten minutes. Thereafter, the amine curing agent C (Adeka hardner EH-6019, manufactured by Adeka Corporation, active hydrogen equivalent: 80 g/eq, an aliphatic amine curing agent which has no phenoxy group and has an amino group not protected) was added, and the resulting mixture was further stirred by a roll coater for ten minutes.

Subsequently, a glass substrate or a lens for evaluation was coated with each light-shielding coating material/curing agent solution thus obtained at a predetermined thickness, and was dried at room temperature for 60 minutes. After being dried, the light-shielding coating material was cured under curing conditions for a light-shielding film including a furnace temperature, as indicated in Tables 1 to 3, to obtain a light-shielding film.

Evaluation of the obtained light-shielding films is indicated in Tables 1 to 3.

TABLE 1

| | | Example 1 | Example 2 | Example 3 | Example 4 | Example 5 | Example 6 | Example 7 |
|---|---|---|---|---|---|---|---|---|
| light-shielding dye | light-shielding dye (g) | 50 | 50 | 50 | 50 | 50 | 50 | 50 |
| | the kind of amine | curing | curing | curing | curing | curing | curing | curing |
| | curing agent | agent A | agent A | agent A | agent A | agent A | agent A | agent A |
| | amount of amine | 4.9 | 0.15 | 1.0 | 4.0 | 9.9 | 14.8 | 19.8 |
| | curing agent (g) | | | | | | | |
| | inorganic fine particles | titania | titania | titania | titania | titania | titania | titania |
| light-shielding film | condition for curing | 40° C. | 40° C. | 40° C. | 40° C. | 40° C. | 40° C. | 40° C. |
| | light-shielding | | | | | | | |
| | film-temperature | | | | | | | |
| | condition for curing | 8 hours | 24 hours | 8 hours | 8 hours | 8 hours | 8 hours | 8 hours |
| | light-shielding | | | | | | | |
| | film-time | | | | | | | |
| | content of dye in | 20 | 20 | 20 | 20 | 20 | 20 | 20 |
| | light-shielding film (% | | | | | | | |
| | by mass) | | | | | | | |
| | mixing equivalent of | 1.0 | 0.03 | 0.2 | 0.8 | 2.0 | 3.0 | 4.0 |
| | amine curing agent | | | | | | | |
| | film thickness (μm) | 23 | 23 | 23 | 23 | 23 | 23 | 23 |
| | content of phenoxy | 11.3 | 0.5 | 3.0 | 9.6 | 17.3 | 21.0 | 23.5 |
| | group in organic | | | | | | | |
| | component in cured | | | | | | | |
| | epoxy resin (% by | | | | | | | |
| | mass) | | | | | | | |
| evaluation result | elution of colorant | A | C | C | A | A | A | C |
| | environmental stability | A | C | B | B | A | B | B |
| | optical | A | A | A | A | A | A | A |
| | property-extinction | | | | | | | |
| | coefficient | | | | | | | |
| | optical | A | A | A | A | A | A | A |
| | property-scattering | | | | | | | |
| | | | | Example | Example | Example | Example | Example |
| | | Example 8 | Example 9 | 10 | 11 | 12 | 13 | 14 |
| light-shielding dye | light-shielding dye (g) | 50 | 50 | 50 | 65 | 65 | 65 | 65 |
| | the kind of amine | curing | curing | curing | curing | curing | curing | curing |
| | curing agent | agent A | agent A | agent A | agent A | agent A | agent A | agent A |
| | amount of amine | 24.7 | 4.0 | 4.0 | 4.0 | 4.0 | 4.0 | 4.0 |
| | curing agent (g) | | | | | | | |
| | inorganic fine particles | titania | titania | titania | titania | titania | titania | titania |
| light-shielding film | condition for curing | 40° C. | 40° C. | 40° C. | 40° C. | 40° C. | 40° C. | 40° C. |
| | light-shielding | | | | | | | |
| | film-temperature | | | | | | | |
| | condition for curing | 8 hours | 8 hours | 8 hours | 8 hours | 8 hours | 8 hours | 8 hours |
| | light-shielding | | | | | | | |
| | film-time | | | | | | | |
| | content of dye in | 20 | 4 | 8 | 28 | 30 | 35 | 50 |
| | light-shielding film (% | | | | | | | |
| | by mass) | | | | | | | |
| | mixing equivalent of | 5.0 | 0.8 | 0.8 | 0.8 | 0.8 | 0.8 | 0.8 |
| | amine curing agent | | | | | | | |
| | film thickness (μm) | 23 | 23 | 23 | 23 | 23 | 23 | 23 |
| | content of phenoxy | 25.3 | 9.6 | 9.6 | 9.6 | 9.6 | 9.6 | 9.6 |
| | group in organic | | | | | | | |
| | component in cured | | | | | | | |
| | epoxy resin (% by | | | | | | | |
| | mass) | | | | | | | |
| evaluation result | elution of colorant | C | B | A | A | A | C | C |
| | environmental stability | B | B | A | A | A | B | B |
| | optical | A | B | A | A | A | A | A |
| | property-extinction | | | | | | | |
| | coefficient | | | | | | | |
| | optical | A | A | A | A | A | A | A |
| | property-scattering | | | | | | | |

TABLE 2

| | | Example | Example | Example | Example | Example | Example | Example | Example | Example |
|---|---|---|---|---|---|---|---|---|---|---|
| | | 15 | 16 | 17 | 18 | 19 | 20 | 21 | 22 | 23 |
| light-shielding | light-shielding dye | 50 | 50 | 50 | 50 | 50 | 50 | 50 | 50 | 50 |
| dye | (g) | | | | | | | | | |
| | the kind of amine | curing | curing | curing | curing | curing | curing | curing | curing | curing |
| | curing agent | agent A | agent A | agent A | agent A | agent A | agent A | agent A | agent A | agent A |
| | amount of amine | 4.9 | 4.9 | 5.6 | 4.0 | 4.9 | 4.9 | 4.9 | 4.9 | 4.9 |
| | curing agent (g) | | | | | | | | | |
| | inorganic fine | zirconia | titania/silica | coal tar/ | titania | titania | titania | titania | titania | titania |
| | particles | | | silica | | | | | | |
| light-shielding | condition for curing | 40° C. | 40° C. | 40° C. | 40° C. | 40° C. | 40° C. | 40° C. | 40° C. | 40° C. |
| film | light-shielding | | | | | | | | | |
| | film-temperature | | | | | | | | | |
| | condition for curing | 8 hours | 8 hours | 8 hours | 8 hours | 8 hours | 8 hours | 8 hours | 8 hours | 8 hours |
| | light-shielding | | | | | | | | | |
| | film-time | | | | | | | | | |
| | content of dye in | 20 | 20 | 20 | 20 | 20 | 20 | 20 | 20 | 20 |
| | light-shielding film | | | | | | | | | |
| | (% by mass) | | | | | | | | | |
| | mixing equivalent | 1.0 | 1.0 | 1.0 | 1.0 | 1.0 | 1.0 | 1.0 | 1.0 | 1.0 |
| | of amine curing | | | | | | | | | |
| | agent | | | | | | | | | |
| | film thickness (μm) | 23 | 23 | 23 | 23 | 0.5 | 2 | 55 | 100 | 120 |
| | content of phenoxy | 11.3 | 11.3 | 20.0 | 11.3 | 11.3 | 11.3 | 11.3 | 11.3 | 11.3 |
| | group in organic | | | | | | | | | |
| | component in | | | | | | | | | |
| | cured epoxy | | | | | | | | | |
| | resin (% by mass) | | | | | | | | | |
| evaluation | elution of colorant | A | A | A | A | B | A | A | A | B |
| result | environmental | B | B | B | A | B | B | B | B | C |
| | stability | | | | | | | | | |
| | optical | A | A | A | A | A | A | A | A | A |
| | property-extinction | | | | | | | | | |
| | coefficient | | | | | | | | | |
| | optical | A | A | A | B | A | A | A | A | A |
| | property-scattering | | | | | | | | | |

| | | Example | Example | Example | Example | Example | Example | Example |
|---|---|---|---|---|---|---|---|---|
| | | 24 | 25 | 26 | 27 | 28 | 29 | 30 |
| light-shielding | light-shielding dye | 50 | 50 | 50 | 50 | 50 | 50 | 50 |
| dye | (g) | | | | | | | |
| | the kind of amine | curing | curing | curing | curing | curing | curing | curing |
| | curing agent | agent A | agent A | agent A | agent A | agent A | agent A | agent A |
| | amount of amine | 4.9 | 4.9 | 4.9 | 4.9 | 4.9 | 4.9 | 4.9 |
| | curing agent (g) | | | | | | | |
| | inorganic fine | titania | titania | titania | titania | titania | titania | titania |
| | particles | | | | | | | |
| light-shielding | condition for curing | 15° C. | 20° C. | 60° C. | 80° C. | 100° C. | 150° C. | 180° C. |
| film | light-shielding | | | | | | | |
| | film-temperature | | | | | | | |
| | condition for curing | 8 hours | 24 hours | 4 hours | 2 hours | 2 hours | 2 hours | 2 hours |
| | light-shielding | | | | | | | |
| | film-time | | | | | | | |
| | content of dye in | 20 | 20 | 20 | 20 | 20 | 20 | 20 |
| | light-shielding film | | | | | | | |
| | (% by mass) | | | | | | | |
| | mixing equivalent | 1.0 | 1.0 | 1.0 | 1.0 | 1.0 | 1.0 | 1.0 |
| | of amine curing | | | | | | | |
| | agent | | | | | | | |
| | film thickness (μm) | 5 | 5 | 5 | 5 | 5 | 5 | 5 |
| | content of phenoxy | 11.3 | 11.3 | 11.3 | 11.3 | 11.3 | 11.3 | 11.3 |
| | group in organic | | | | | | | |
| | component in | | | | | | | |
| | cured epoxy | | | | | | | |
| | resin (% by mass) | | | | | | | |
| evaluation | elution of colorant | C | A | A | A | A | A | C |
| result | environmental | B | B | B | B | B | B | B |
| | stability | | | | | | | |
| | optical | A | A | A | A | A | A | A |
| | property-extinction | | | | | | | |
| | coefficient | | | | | | | |
| | optical | A | A | A | A | A | A | A |
| | property-scattering | | | | | | | |

TABLE 3

| | | Example | Example | Example | Example | Example | Example |
|---|---|---|---|---|---|---|---|
| | | 31 | 32 | 33 | 34 | 35 | 36 |
| light-shielding | light-shielding dye | 50 | 50 | 50 | 50 | 50 | 50 |
| dye | (g) | | | | | | |
| | the kind of amine | curing | curing | curing | curing | curing | curing |
| | curing agent | agent B | agent B | agent B | agent A | agent C | agent C |
| | amount of amine | 3.8 | 4.8 | 9.6 | 4.9 | 5.8 | 3.7 |
| | curing agent (g) | | | | | | |
| light-shielding | inorganic fine | titania | titania | titania | titania | titania | titania |
| film | particles | | | | | | |
| | condition for curing | 40° C. | 40° C. | 40° C. | 40° C. | 40° C. | 40° C. |
| | light-shielding | | | | | | |
| | film-temperature | | | | | | |
| | condition for curing | 8 hours | 8 hours | 8 hours | 8 hours | 8 hours | 8 hours |
| | light-shielding | | | | | | |
| | film-time | | | | | | |
| | content of dye in | 20 | 20 | 20 | 0 | 20 | 20 |
| | light-shielding film | | | | | | |
| | (% by mass) | | | | | | |
| | mixing equivalent of | 0.8 | 1.0 | 2.0 | 1.0 | 1.0 | 1.0 |
| | amine curing agent | | | | | | |
| | film thickness (μm) | 23 | 23 | 23 | 23 | 23 | 23 |
| | content of phenoxy | 8.3 | 9.7 | 15.0 | 11.3 | 12.0 | 12.3 |
| | group in organic | | | | | | |
| | component in cured | | | | | | |
| | epoxy resin (% by | | | | | | |
| | mass) | | | | | | |
| evaluation | elution of colorant | A | A | A | A | B | A |
| result | environmental | A | A | A | A | A | A |
| | stability | | | | | | |
| | optical | A | A | A | A | A | A |
| | property-extinction | | | | | | |
| | coefficient | | | | | | |
| | optical | A | A | A | B | B | B |
| | property-scattering | | | | | | |

### Comparative Examples

In Comparative Examples 1 to 8, a light-shielding film was manufactured in a similar manner to Example 1 except that the composition was changed to that in Table 4. In Table 4, the amine curing agent C is Adeka hardner EH-6019 (manufactured by Adeka Corporation, active hydrogen equivalent: 80 g/eq, an aliphatic amine curing agent which has no phenoxy group and has an amino group not protected), and an amine curing agent D is Adeka hardner EH-235R-2 (manufactured by Adeka Corporation, active hydrogen equivalent: 95 g/eq, an amine curing agent which has no phenoxy group and has a primary amino group protected by a carbonyl compound).

The obtained light-shielding films were evaluated in a similar manner to Example 1. Evaluation results are indicated in Table 4.

TABLE 4

| | | Comparative | Comparative | Comparative | Comparative |
|---|---|---|---|---|---|
| | | Example 1 | Example 2 | Example 3 | Example 4 |
| light-shielding dye | light-shielding dye (g) | 50 | 50 | 50 | 50 |
| | the kind of amine | curing agent C | curing agent C | curing agent C | curing agent C |
| | curing agent | | | | |
| | amount of amine | 2.2 | 4.4 | 7.4 | 11.1 |
| | curing agent (g) | | | | |
| | inorganic fine particles | titania | titania | titania | titania |
| light-shielding film | condition for curing | 40° C. | 40° C. | 40° C. | 40° C. |
| | light-shielding | | | | |
| | film-temperature | | | | |
| | condition for curing | 8 hours | 8 hours | 8 hours | 8 hours |
| | light-shielding | | | | |
| | film-time | | | | |
| | content of dye in | 19 | 19 | 19 | 19 |
| | light-shielding film (% | | | | |
| | by mass) | | | | |
| | mixing equivalent of | 0.6 | 1.2 | 2.0 | 3.0 |
| | amine curing agent | | | | |
| | film thickness (λm) | 15 | 24 | 8 | 27 |
| | content of phenoxy | 0 | 0 | 0 | 0 |
| | group in organic | | | | |
| | component in cured | | | | |
| | epoxy resin (% by | | | | |
| | mass) | | | | |
| evaluation result | elution of colorant | D | D | D | D |
| | environmental stability | A | B | B | C |
| | optical | A | A | A | A |
| | property-extinction | | | | |
| | coefficient | | | | |
| | optical | A | C | C | C |
| | property-scattering | | | | |
| | | Comparative | Comparative | Comparative | Comparative |
| | | Example 5 | Example 6 | Example 7 | Example 8 |
| light-shielding dye | light-shielding dye (g) | 50 | 50 | 50 | 50 |
| | the kind of amine | curing agent D | curing agent D | curing agent D | curing agent D |
| | curing agent | | | | |
| | amount of amine | 2.6 | 4.4 | 8.8 | 13.2 |
| | curing agent (g) | | | | |
| | inorganic fine particles | titania | titania | titania | titania |
| light-shielding film | condition for curing | 40° C. | 40° C. | 40° C. | 40° C. |
| | light-shielding | | | | |
| | film-temperature | | | | |
| | condition for curing | 8 hours | 8 hours | 8 hours | 8 hours |
| | light-shielding | | | | |
| | film-time | | | | |
| | content of dye in | 19 | 20 | 20 | 20 |
| | light-shielding film (% | | | | |
| | by mass) | | | | |
| | mixing equivalent of | 0.6 | 1.0 | 2.0 | 3.0 |
| | amine curing agent | | | | |
| | film thickness (λm) | 22 | 25 | 35 | 18 |
| | content of phenoxy | 0 | 0 | 0 | 0 |
| | group in organic | | | | |
| | component in cured | | | | |
| | epoxy resin (% by | | | | |
| | mass) | | | | |
| evaluation result | elution of colorant | D | D | D | D |
| | environmental stability | A | A | A | A |
| | optical | A | A | A | A |
| | property-extinction | | | | |
| | coefficient | | | | |
| | optical | A | A | A | A |
| | property-scattering | | | | |

### Test for Incorporation Into Telephoto Lens

Each of the light-shielding films in Examples 1 to 34 was formed on an optical element to be incorporated into a telephoto lens, and the resulting optical element was incorporated into a lens barrel. Optical elements obtained by sticking a plurality of glass lenses with an adhesive resin were used for some optical elements incorporated into the lens barrel. An optical element provided with the light-shielding film of an aspect of the present disclosure was used for each optical element incorporated into the telephoto lens. When a telephoto lens on which the light-shielding film for an optical element of an aspect of the present disclosure had been formed was set into a camera and photographing was performed, a photographed image did not have a flare or a ghost, and excellent performance as a telephoto lens was obtained.

### (Evaluation)

In Examples 1 to 8, the content of a phenoxy group in a cured epoxy resin was changed from 0.5% by mass to 25.3% by mass. In Examples 9 to 14, the content of a colorant in a light-shielding film was changed from 4% by mass to 50% by mass. In Examples 15 to 17, a compound other than titania was used for adjusting a refractive index. In Example 18, titania particles having a large particle diameter were used. In Examples 19 to 23, the film thickness of a light-shielding film was changed from 0.5 μm to 120 μm. In Examples 24 to 30, conditions for curing a light-shielding film were changed. In Examples 31 to 33, the curing agent was changed. In Example 34, a pigment was used in place of a dye. In Examples 35 and 36, a curing agent having a different epoxy group and phenoxy group was used. It has been found that the light-shielding films in Examples 1 to 36 suppress elution of a colorant and has excellent environmental stability. Optical elements provided with the light-shielding films in Examples 1 to 36 suppressed a flare or a ghost.

The light-shielding film of the present disclosure can be used for a light-shielding film of an optical element used for an optical apparatus such as a camera, binoculars, a microscope, or a semiconductor exposure apparatus. The light-shielding film of the present disclosure can be used for an optical element such as a lens or a prism due to a reduced elution amount of a dye in manufacturing.

The present disclosure can provide an optical element which has high solvent resistance and is provided with a light-shielding film having excellent environmental stability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-040720, filed Mar. 2, 2015, which is hereby incorporated by reference herein in its entirety.

What is claimed is:

1. An optical element comprising a substrate and a light-shielding film in a part of the substrate,
wherein the light-shielding film contains a resin and a colorant, and
the resin is a cured epoxy resin having a first aryl unit represented by Formula (1) below in a side chain or a terminal. 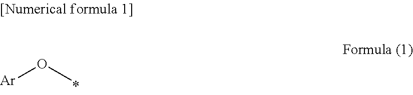
[In the formula, Ar represents a monocyclic unsubstituted aryl group, a polycyclic unsubstituted aryl group, a monocyclic substituted aryl group, or a polycyclic substituted aryl group.]

2. The optical element according to claim 1,
wherein the first aryl unit is a phenyl unit represented by Formula (2) below. 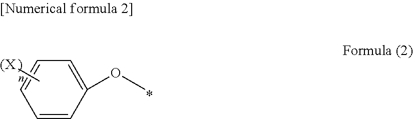
[In the formula, X represents an electron-donating group, and n represents an integer of 0 or more and 5 or less.]

3. The optical element according to claim 2,
wherein the electron-donating group is —OCH₃—, —OH—, or —NR₂— [in the formula, R represents an alkyl group].

4. The optical element according to claim 1,
wherein the first aryl unit is a unit represented by Formula (3) below.

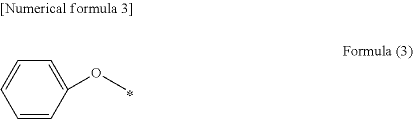

5. The optical element according to claim 1,
wherein the substrate is a lens having a resin layer between glass plates.

6. The optical element according to claim 1,
wherein the colorant is a dye.

7. The optical element according to claim 1,
wherein the light-shielding film further contains inorganic fine particles having a number average particle diameter of 100 nm or less and a refractive index nd of 2.2 or more.

8. The optical element according to claim 7,
wherein the inorganic fine particles are titania fine particles and/or zirconia fine particles.

9. The optical element according to claim 4,
wherein the cured epoxy resin has a content of a phenoxy group of 0.5% by mass or more and 25.3% by mass or less.

10. A light-shielding coating material set for an optical element, comprising a unit A containing an epoxy resin and a unit B containing a curing agent,
wherein the light-shielding coating material set contains a colorant and an organic solvent in the unit A or/and the unit B, and
the curing agent has a first aryl unit represented by Formula (1) below. 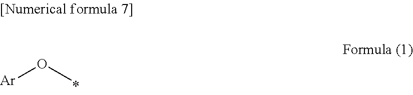
[In the formula, Ar represents a monocyclic unsubstituted aryl group, a polycyclic unsubstituted aryl group, a monocyclic substituted aryl group, or a polycyclic substituted aryl group.]

11. The light-shielding coating material set according to claim 10,
wherein the first aryl unit is a unit represented by Formula (3) below.

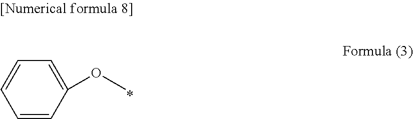

12. The light-shielding coating material set according to claim 10,
wherein the curing agent is a compound having a second unit represented by Formula (4) below. 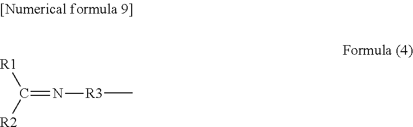
[In the formula, each of R1 and R2 represents a hydrogen atom or an alkyl group having 1 to 8 carbon atoms, and R3 represents an alkyl chain or an aromatic ring having 1 to 8 carbon atoms.]

13. A method for manufacturing an optical element, comprising:
coating an outer periphery of a substrate with a light-shielding coating material containing at least an epoxy resin, a colorant, and a curing agent having a first unit represented by Formula (1) below, 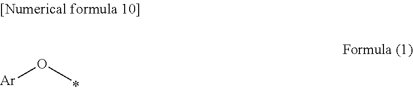
[In the formula, Ar represents a monocyclic unsubstituted aryl group, a polycyclic unsubstituted aryl group, a monocyclic substituted aryl group, or a polycyclic substituted aryl group.], and
curing the coating material with which the substrate has been coated at a temperature of 20° C. to 100° C.

14. The method for manufacturing an optical element according to claim 13,
wherein the substrate is glass or a lens.

15. The method for manufacturing an optical element according to claim 13,
wherein the substrate is a lens having a resin layer between glass plates.
